(19) United States
(12) Patent Application Publication
(10) Pub. No.: US 2003/0202350 A1
(43) Pub. Date: Oct. 30, 2003

(54) Solid state tower beacon lamp

(76) Inventors: Michael MacGregor Mac Dougall, Innisfail (CA); Edward Melcarek, Barrie (CA)

Correspondence Address: Santosh K. Chari, McCarthy Tetrault LLP, 66 Wellington Street West, Suite 4800, P.O. Box 48, Toronto, ON, M5K 1E6, CA

(21) Appl. No.: 10/442,114

(22) Filed: May 21, 2003

Related U.S. Application Data
(63) Continuation of application No. PCT/CA01/01614, filed on Nov. 21, 2001.

(30) Foreign Application Priority Data
Nov. 21, 2000 (CA) 2,325,708

(51) Int. Cl. F21S 2/00

(52) U.S. Cl. 362/257

(57) ABSTRACT

A high intensity solid state light pulse generator, has a low voltage, low range radio frequency carrier wave generator, the output of which is modulated by a low frequency sweep signal, to generate sonoluminescent light pulses visible to the human eye, within a desired spectrum. The modulating sweep signal can be computer generated in a predetermined mode, for a range of outputs. In one embodiment, a carrier wave at 450 kHz is modulated by way of an input in the audio range of 20 to 20,000 Hz. The colour of the output pulses is held to be a function of the modulating frequency. By selection of a suitable modulating frequency, monochromatic light pulses of a predetermined colour may be provided. A semi-mirror laser technique is used in order to amplify the light pulses, to achieve high intensity bursts of light at reduced frequency. The modulator RF output is a double sideband signal that is amplified by way of a linear amplifier, to drive a pair of physically opposed piezo-ceramic modules, in synchronous, in-phase relation. The piezo-ceramic modules, in the form of annular “washers” are located in mutually spaced relation, at the opposite ends of a glass lens, through which phonon wavefronts are propagated. Photo-transistor sensors located adjacent the glass lens provides a monitoring and feed-back circuit, primarily to ensure satisfactory operation of the beacon, while enabling automatic control of the voltage of the system power supply, and enabling the occurrence of asymmetry in light output to be detected.

This application is a Continuation of PCT application number PCT/CA01/01614 filed on Nov. 21, 2001, which claims priority from Canadian application number 2,325,708, filed Nov. 21, 2000.

### BACKGROUND OF THE INVENTION

1. Field of the Invention

This invention is directed to a tuneable laser, and in particular to a system utilizing a tuneable laser to provide a solid state high intensity light

2. Description of the Prior Art

Beacon safety lights, by means of which towers such as radio towers, tall buildings and the like are marked, frequently consist of “strobe” lights that generate a continuous sequence of high intensity light flashes of short duration. These lights use high voltage, flash tube technology, which compromises their performance, on account of high heat generation and disadvantageous generation of induced electromagnetic fields, which over time can interfere with the circuitry of solid state electronics. The heat factor involves low over-all efficiency, and reduced service life.

An alternative form of light generation, referred to as sonoluminescence has been observed, being generated in water during the collapse of sonically induced bubbles, when a high intensity flash of extremely short duration has occurred. One publication relating to this phenomena is Physical Review Letters, May 1996; Claudia Eberlain et al; Cambridge University, U.K.

### SUMMARY OF THE INVENTION

The present invention provides a solid state light pulse generator for generating high intensity light, utilizing a low voltage, low range radio frequency carrier wave generator, the output emission of which is modulated by a low frequency sweep signal, to generate light pulses visible to the human eye, within a desired spectrum.

A modulating sweep signal can be computer generated in a predetermined mode, for a range of selective outputs.

In one embodiment, a carrier wave at 450 kHz is modulated by way of an input in the audio range of 20 to 20,000 Hz. The colour of the output pulses is held to be a function of the modulating frequency. By selection of a suitable modulating frequency, monochromatic light pulses of a predetermined colour may be provided.

The audio range modulating signal is computer generated as a programmed composite wave-form, in the Fourier domain, having a predetermined series of chromatic intervals, the output of which is applied to a balanced modulator that also receives the 450 kHz carrier wave. The modulator RF (radio frequency) output, when in a balanced state, appears as a double sideband signal which is amplified, to power a linear amplifier, the output of which drives a pair of piezo-ceramic modules, in synchronous, in-phase relation. The piezo-ceramic modules, in the form of annular “washers” are located in mutually spaced relation, at the opposite ends of a glass lens, through which phonon wavefronts may be propagated.

The piezo-ceramic modules, driven in-phase by the linear amplifier, generate opposing wave-fronts within the glass, to create the desired sonoluminescence, with bursts of light in a range of wavelengths extending within and beyond the visible spectrum.

Surfaces of the glass lens may have reflective coatings that serve to build up the internal energy to a sufficient level that emission takes place through a selected one of the reflective coatings.

Sonoluminescent emission is dependent upon the composite, computer generated waveform, which is programmed through digital domain software and can be computer-stored for ready access as a “wave file”.

These waveforms can be remotely accessed by way of modem, for editing and modification. The glass lens is provided with an external profile, which in the case of a field beacon has 360 degrees of beam coverage. The extent of beam divergence is a function of the curvature of the lens, which also relates inversely with beam intensity.

The provision of photo-transistor sensors adjacent the glass lens enables the provision of a monitoring and feed-back circuit, primarily to ensure satisfactory operation of the beacon, while enabling automatic control of the voltage of the system power supply. By connecting two such phototransistors in series, the occurrence of asymmetry in light output may be detected.

### BRIEF DESCRIPTION OF THE DRAWINGS

These and other features of the preferred embodiments of the invention will become more apparent in the following detailed description in which reference is made to the appended drawings wherein:

FIG. 1 is a side elevation in partial diametrical section of a beacon light in accordance with the present invention, having a 360-degree field of illumination;

FIG. 2 is a similar view of the glass lens of the FIG. 1 embodiment;

FIG. 3 is a circuit diagram for the beacon system of FIG. 1; and,

FIG. 4 is a schematic representation of a composite audio signal, as used in the system.

### DESCRIPTION OF THE PREFERRED EMBODIMENTS

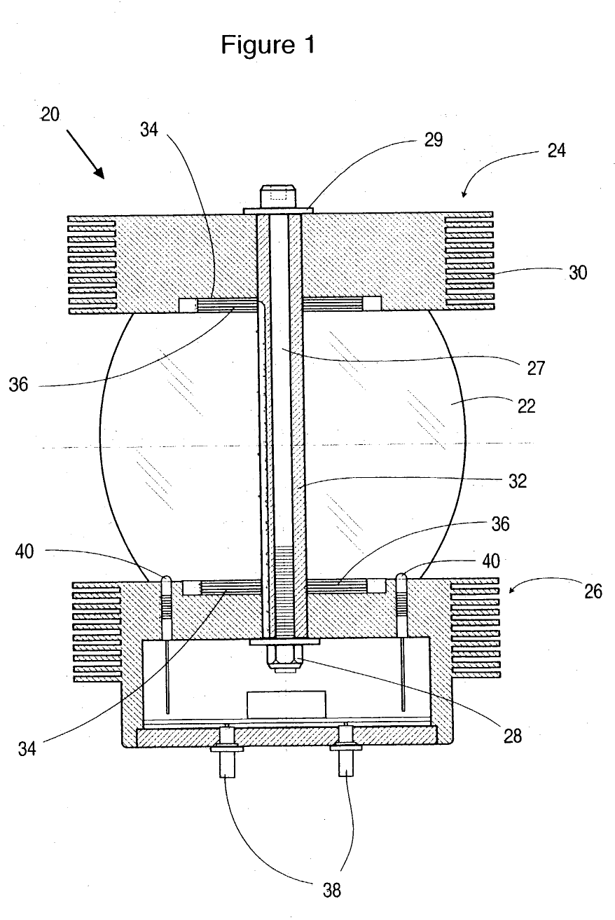

Referring to FIG. 1, a field beacon 20, such as is required upon elevated structures as an aircraft hazard beacon has an annular truncated spherical glass lens body 22, compressed between end fittings 24, 26 by way of a central bolt 27 and nut 28, with washers 29.

The metal end fittings 24, 26 have cooling fins 30, to promote stable thermal conditions.

An insulating sleeve 32 electrically isolates the bolt 27, and provides an insulated conductor conduit between the opposed ends of the beacon 20.

Each end fitting 24, 26 contains a piezo annular “washer shaped” module 32, the outer surfaces 34 of which are at ground potential, the inner surfaces 36 being connected to the modulated inputs from the system circuit, by way of a pair of R.F connectors 38.

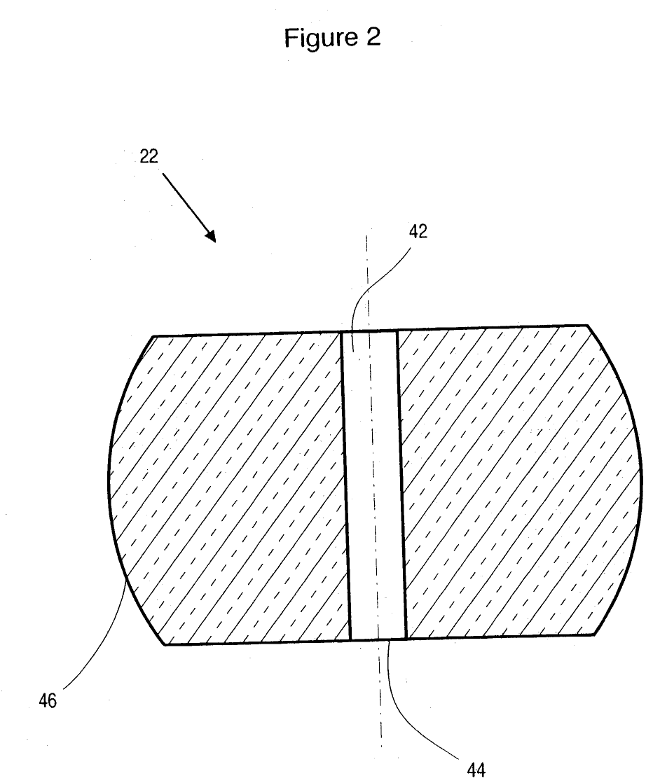

A pair of photo-transistor sensors 40 located in the lower end fitting 26 abut the glass lens 22. Referring to FIG. 2, the truncated spherical glass lens 22 has an axial passage 42 therethrough, protectively coated with an aluminized, 100% reflective coating 44. The curved outer surfaces have a partially reflective coating 46 that provides 30% reflectivity.

The end surfaces that abut the piezzo generators are non-reflecting, and may be frosted.

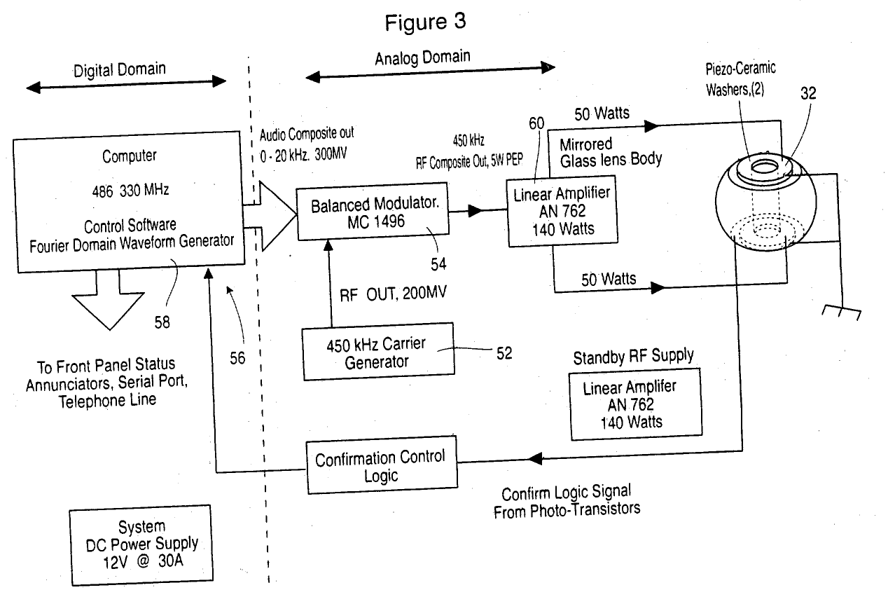

Referring to FIG. 3, the system driving circuit 50 has a 460 kHz carrier wave generator 52 supplying its RF output to a balanced modulator 54, the output of which is dependent upon the provision of a modulation input signal. Thus, the modulator 54 also receives a low frequency modulation signal from a generating circuit 56 that is based upon a computer 58 having waveform generating software. A commercial software package “Orangstor” generates a Fourier series waveform output in the acoustic range 20 to 20,000 Hz., as a “sum and difference” complex, to a second order of harmonics, of up to ten separate wave forms, played simultaneously. The system is configured to provide individual modulation of frequency, amplitude and phase for each waveform. The waveform outputs can then be selectively combined as a composite, including sweep capability, and can be recorded as computer wave files. These files can be accessed, to provide selected waveform audio outputs as modulation signals to the wave generator 52.

By balancing the signal inputs, the carrier frequency can be suppressed, to produce a modulated RF output double side-band signal that is connected to a linear amplifier 60.

The amplified output passes as separate, in-phase signals to the respective piezo modules 32, by way of the R.F. connectors 38.

The photo transistors 40 are connected as a feed-back to the computer 58, where a confirmation control logic verifies the authenticity of the beacon output as being within pre-defined parameter limits.

The computer 58 has a ‘front’ control panel, and also a status enunciator, a serial port, a telephone module connection, etc that enables both local and remote monitoring and control. In one embodiment the RF carrier wave generator 52 has an output of about 200 mV. The low frequency modulating signal from the computer 58 is at about 300 mV.

The modulator 54 has an output signal of about 5 watts, which is boosted by the linear amplifier 60 to twin, in-phase outputs of about 50 watts each to the respective piezo modules 32.

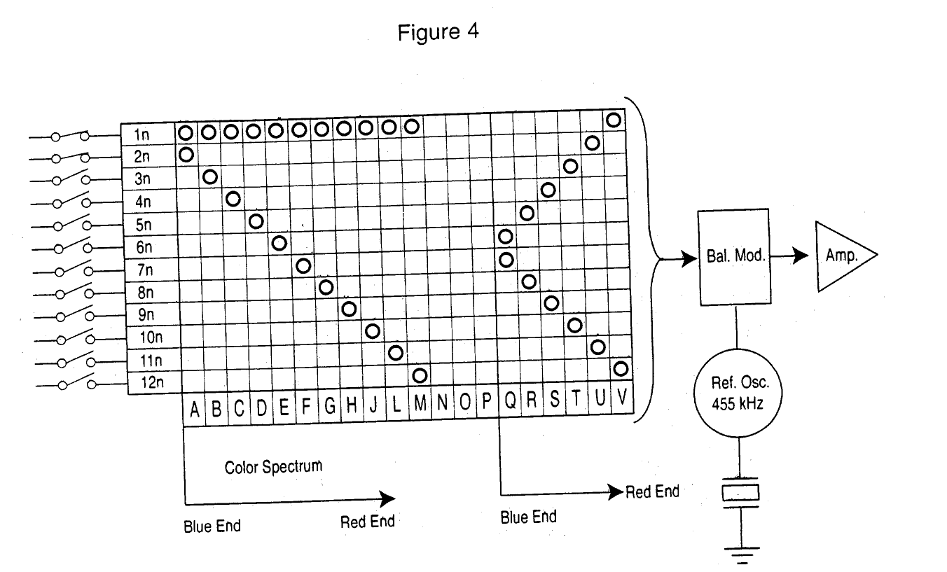

Referring to FIG. 4, this illustrates in tabular form the visible spectrum associated with the modulating frequencies, wherein the lower frequencies are associated with the longer wavelengths of the blue end of the spectrum and the higher frequencies are associated with the shorter wavelengths of the red end of the spectrum.

As indicated above, in one embodiment, the present invention is particularly suited for use in the aerospace industry such as beacon lighting used in radio towers or other high structures (e.g. buildings etc.). In addition, the light source of the present invention can also be used in lighting systems for airport runways or airport navigational lighting. In another embodiment, the invention can be used for street lighting, interior (household) lighting, lighting for areas of high heat or severe cold (e.g. stoves, freezers etc.), vehicular lighting (trains, planes, automobiles etc.), signal lighting such as traffic lights, and other applications that will be apparent to persons skilled in the art. Further, the invention may also be scaled down for use in television, computer monitors, screen viewers etc.

Although the invention has been described with reference to certain specific embodiments, various modifications thereof will be apparent to those skilled in the art without departing from the spirit and scope of the invention as outlined in the claims appended hereto.

The embodiments of the invention in which an exclusive property or privilege is claimed are defined as follows:

1. A light pulse generator having a translucent body; at least one mechanical pulse generator means secured to said body, for applying selectively controllable physical force to the body; first signal generating means for generating a high frequency carrier wave first signal; second signal generating means for generating a low frequency second signal substantially within the audio range; signal modulator means for combining said first and said second signals into a third signal; amplifier means for amplifying the power of said third signal and having a pair of outputs, and conductor means connecting one of said amplifier outputs to said pulse generator and the other in physical opposition thereto, whereby, in use said generator generates bursts of sonoluminescence.

2. The light pulse generator as set forth in claim 1, wherein said translucent body is glass.

3. The light pulse generator as set forth in claim 1, wherein said translucent body has an outer surface profiled as a surface of revolution, to provide a predetermined field of light emission.

4. The light pulse generator as set forth in claim 3, wherein said surface of revolution is a truncated sphere.

5. The light pulse generator as set forth in claim 4 wherein said at least one pulse generator comprises a pair of piezo electric actuators secured to opposed faces of said truncated sphere, in intimate contact therewith.

6. The light pulse generator as set forth in claim 5, said truncated sphere having a central bore; and a tension member extending therethrough, securing said piezo electric actuators in compressed sandwiched relation with said truncated sphere.

7. The light pulse generator as set forth in claim 1, said first signal being in the range 200 to 600 kHz.

8. The light pulse generator as set forth in claim 1, said first signal being at 450 kHz.

9. The light pulse generator as set forth in claim 8, said second signal being in the range 20 to 20,000 Hz.

10. The light pulse generator as set forth in claim 1, said amplifier means being a linear amplifier.

11. The light pulse generator as set forth in claim 1, including radiation monitoring means adjoining said translucent body, to detect the generation of light therein.

12. The light pulse generator as set forth in claim 6, said truncated sphere having opposed planar end portions; a highly reflective surface finish on said planar end portion and said central bore; and a semi-reflective surface finish on the curved surface of said truncated sphere, to promote a build-up of light intensity within said truncated sphere, with burst emission through said semi-reflective surface

13. The light pulse generator as set forth in claim 12, said semi-reflective surface finish having a reflective factor of about substantially 30 percent.

14. The light pulse generator as set forth in claim 11, said radiation monitoring means comprising a pair of photo-transistors in mutually spaced relation, being in series connection, to enable detection of asymmetrical light propagation.

15. The light pulse generator as set forth in claim 1, in combination with a computer programmed to generate said low frequency second signal.

16. The method of generating sonoluminescence, consisting of the steps of applying phonon energy to the opposed ends of a solid translucent body, to provide mutual wave-front interference at low frequency within the body, to generate said sonoluminescence.

17. The method of generating sonoluminescence, as set forth in claim 16, including the step of reflecting said sonoluminescence within said body by way of a semi-reflective coating on a selected surface of said body, until an energy level is built up sufficient to penetrate the semi-reflective coating, enabling the emission of a burst of light from said selected surface.
